(19) United States
(12) Patent Application Publication
(10) Pub. No.: US 2023/0271479 A1
(43) Pub. Date: Aug. 31, 2023

(54) ELECTRIC FLUID HEATER

(71) Applicant: Valeo Autosystemy Sp. z o.o., Skawina (PL)

(72) Inventors: Dawid SZOSTEK, Skawina (PL); Damian JURKIEWICZ, Skawina (PL); Dariusz BUREK, Skawina (PL)

(73) Assignee: Valeo Autosystemy Sp. z o.o., Skawina (PL)

(21) Appl. No.: 18/006,612

(22) PCT Filed: Jul. 8, 2021
(86) PCT No.: PCT/EP2021/069060

§ 371 Date: Jan. 24, 2023

(30) Foreign Application Priority Data
Jul. 26, 2020 (EP) 20461552.0

(51) Int. Cl. B60H 1/22; F24H 3/04

(52) U.S. Cl. CPC B60H 1/2225; F24H 3/0429

(57) ABSTRACT

Electric fluid heater for a vehicle, including a heating block with an inlet and an outlet for the fluid, a first channel for the fluid intended to flow between the inlet and the outlet, a first tube and a second tube with opposing ends mounted in headers, the tubes having heating elements. The first channel is delimited by a top plate and a bottom plate sealingly connected to the first tube, the second tube and the headers.

### FIELD OF THE INVENTION

The field of the present invention is that of devices for heating and circulating a fluid for vehicles. The invention applies more particularly to electric heating and/or air-conditioning devices for motor vehicles comprising such devices.

### BACKGROUND OF THE INVENTION

It is known that the heating of the air intended for heating the passenger compartment of a motor vehicle, or for demisting or defrosting, is provided by the passage of a flow of air through a heat exchanger, more precisely by a heat exchange between this flow of air and a fluid circulating inside the exchanger. This can in particular be the cooling fluid in the case of a heat engine.

In the case of an electric vehicle, it is also known to use an air-conditioning loop operating in heat pump mode for air heating. However, this mode of air heating can also be unsuitable or insufficient.

This is because the performance of the air-conditioning circuit in heat pump mode depends on the outdoor climatic conditions. For example, when the outside air is too cold, the air cannot be heated to a temperature sufficient to warm the passenger compartment. In this context, it is known to add to the fluid circulation loops an additional electric device for thermal conditioning of the fluid such as an additional electric heating device. Such an additional electric heating device can be adapted to heat a suitable fluid upstream of the heat exchanger. In a known way, such an electric additional heating device comprises one or more thermal modules in contact with the fluid to be heated. More precisely, and as can be disclosed in particular in document WO15082434, a thermal module can comprise a core and a heating element surrounding the core, both being spaced apart in order to define a fluid circulation space between the core and the inner surface of the heating element. The heating element is a source of thermal energy. The heating element has electric heating means, e.g. one or more heating resistors serigraphically formed as serigraphic resistive tracks on the outer surface of the heating element. A fluid circulation in the circulation space between the core and the heating element ensures a heat transfer between the heating element and the fluid. In order to obtain sufficient heating power for the desired operation, it can be necessary to multiply the thermal modules in the same additional electric heating device.

Fluid circulation is facilitated by a pump, which is arranged upstream or downstream of the heat exchanger on a fluid circulation pipe.

The present invention relates to an electric heating block, such as a heating block for a motor vehicle. Electric heating block comprising tubes for receiving heating elements are known as electric heating blocks. Such heating elements include, for example, PTC (positive temperature coefficient) resistors. Such heating blocks also include heat sinks, e.g. fins, in thermal contact with the heating elements. The tubes serve to electrically insulate the heating elements from the outside while allowing thermal conduction between the heating elements and the heat sinks.

It would be desirable to provide an electric heater design which would be cost efficient and/or simple to manufacture.

### SUMMARY OF THE INVENTION

The object of the invention is an electric fluid heater for a vehicle, comprising a heating block comprising an inlet and an outlet for the fluid, a first channel for the fluid intended to flow between the inlet and the outlet, a first tube and a second tube with opposing ends mounted in headers, the tubes comprising heating elements, characterized in that the first channel is delimited by a top plate and a bottom plate sealingly connected to the first tube, the second tube and the headers.

Preferably, the first tube and the second tube comprise two side walls connecting the large walls, wherein the top plate and the bottom plate are connected to side walls of the first tube and the second tube.

Preferably, the large walls of the first tube and the second tube are arranged perpendicularly with respect to the top plate and the bottom plate.

Preferably, a side plate is connected parallel to the first tube and/or the second tube on the exterior of the heating block.

Preferably, the side plate is distanced from the headers and the top plate and the bottom plate.

Preferably, the top plate comprises at at least one of the end portions a raised section.

Preferably, the bottom plate comprises at at least one of the end portions a raised section.

Preferably, the inlet and the outlet are each connected to one of the raised sections.

In one option, both the inlet and the outlet are connected to the top plate.

In another option, wherein the inlet is connected to the top plate, while the outlet is connected to the bottom plate.

Preferably, the headers comprise a pair of protrusions extending perpendicularly to the axis of the first tube and/or the second tube.

Preferably, between the first tube and the second tube there is one or more further tubes.

### BRIEF DESCRIPTION OF DRAWINGS

Examples of the invention will be apparent from and described in detail with reference to the accompanying drawings, in which:

FIG. 1 shows an electric heater according to the invention;

FIG. 2 shows an example of heater tube;

FIG. 3 shows a partial cross-section of the heater of FIG. 1;

FIG. 4 presents another configuration of the heater; and

FIG. 5 shows yet another configuration of the heater.

### DETAILED DESCRIPTION OF THE INVENTION

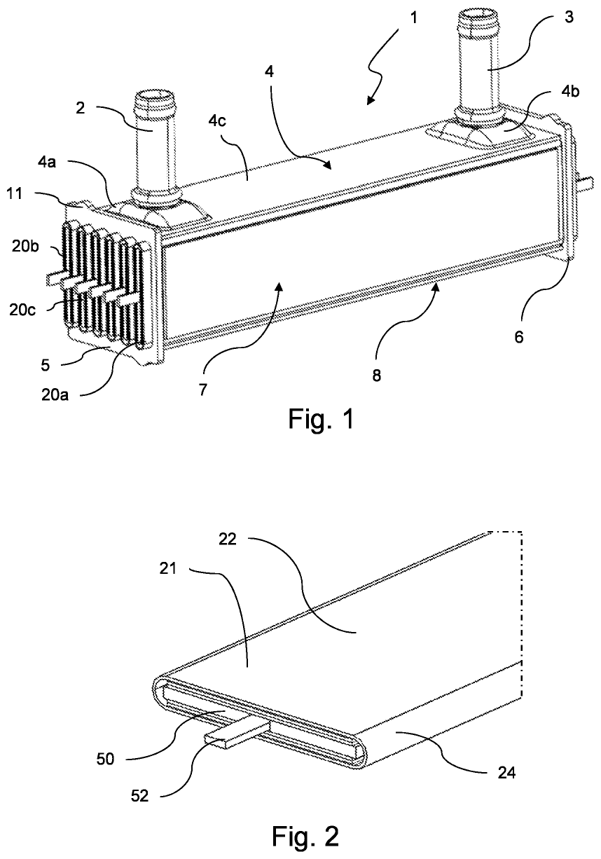

As illustrated in FIG. 1, the invention relates to an electric heating block 1 for an electric fluid heater. The said electric heating block 1 is intended to be supplied with electric current to heat a fluid passing through the electric heating block 1.

The electric heating block 1 advantageously presents a substantially parallelepipedal configuration. It is intended to exchange heat with a fluid passing between an inlet 2, between and/or around tubes 20, and outlet 3. The tubes 20 comprise at least a first tube 20a and a second tube 20b.

The electric fluid heater comprises the electric heating block 1 comprising an inlet 2 and an outlet 3 for the fluid. Therein, a first channel 100 for the fluid intended to flow between the inlet 2 and the outlet 3 is formed. The electric fluid heater further comprises a first tube 20a and a second tube 20b with opposing ends mounted in headers 5, 6, wherein the tubes 20a, 20b comprise heating elements 50. The first channel 100 is delimited by a top plate 4 and a bottom plate 8 sealingly connected to the first tube 20a, the second tube 20b and the headers 5, 6. The tubes 20 are mounted in headers 5 and 6, which in turn are connected by top plate 4. To the top plate 4 there can be connected also the inlet 2 and the outlet 3 for the fluid. In particular, the top plate 4 can comprise raised sections 4a and 4b, which are connected to each other by a connecting section 4c. Since the raised sections 4a and 4b are located at a different distance from the tubes 20 than the connecting section 4c, i.e. at the greater distance from the tubes 20, the fluid is enabled to flow more freely in the vicinity of the inlet 2 and the outlet 3, thereby facilitating its distribution between and/or around the tubes 20. The first channel 100 for the fluid is closed from the bottom by the bottom plate 8, so that the fluid path is limited and an efficient heat exchange with the tubes 20 can take place. The headers 5, 6 can comprise protrusions 11 serving as positioning aid during assembly. This can be useful if slots for the tubes 20 are of different character between two sides of the headers 5, 6, e.g. slots on one side can have widening for facilitated insertion of tubes during assembly. Optionally, a side plate 7 is connected parallel to the first tube 20a and/or the second tube 20b on the exterior of the heating block 1, for thermal insulation and/or for improving the rigidity of the assembly. In one option, the side plate 7 can be distanced from the headers 5, 6 and the top plate 4 and the bottom plate 8.

FIG. 2 shows an example of a tube 20 for the electric fluid heater. The heating block 1 here comprises several tubes 20 and, preferably, several fins 30, or turbulators, alternately stacked in a vertical stacking direction as shown in the figure. The tubes 20 are positioned parallel to each other. These tubes 20 are used to electrically insulate and protect the heating element(s) 50 from the outside. The fins 30 form heat sinks, which increase the heat exchange surface with the fluid.

The heating elements 50 are, for example, PTC resistors (for positive temperature coefficient). Each tube 20 can have several heating elements 50, which can be arranged one after the other in a direction of the tube 20. The heating elements 50 are preferably distributed evenly along the tubes 20.

The tubes 20 together with the heating elements 50 form heating units. The heating units are preferably supplied with power selectively. This means that the heating elements 50 of each heating unit are supplied with current independently of the heating elements 50 of the other heating units and can therefore be supplied with a different current, in particular in terms of its intensity, from the current flowing through the other heating units.

The heating units also have electrodes 52 on both sides of the heating elements 50 for their power supply. The heating units further comprise electrically insulating and thermally conductive material layers, said layers being located between one of the electrodes 52 and a large wall 21 of the tube 20. In this way, the tube 20 is electrically insulated from the electrodes 52 and the heating elements 50 but thermally in contact with them.

Preferably, in each of the heating units, said heating elements 50 are electrically connected in parallel, in particular by means of the electrodes 52.

The fins 30 are in thermal contact with the tubes 20. The fins 30 are positioned between the tubes 20, in particular between the large walls 21 of the tubes 20.

The tubes 20 have two side walls 24 connecting the large walls 21. The large walls 21 each have an external face 22 to which the fin 10 is fixed and an internal face intended to come into thermal contact with the heating elements 50. Thermal contact involves heat exchange between the elements, even if the elements are not in direct physical contact with each other. The function of the large walls 21 is to transmit the heat generated by the electric heating elements 50 to the fins 30. The tube 20 can be made of any material suitable for use in an electric heating block 1. In particular, tube 20 is made of aluminium and/or aluminium alloy.

The top plate 4 and the bottom plate 8 are sealingly connected to side walls 24 of the first tube 20a and the second tube 20b.

Advantageously, the inner faces of the side walls 24 of the tube 20 have a substantially vertical profile, if necessary slightly rounded.

Both the large walls 21 and the side walls 24 are made from the material of the tube 20. Even if several parts are defined, the tube 20 is a single piece.

The fin 30 is advantageously attached to one or both of the large walls 21 of tube 20 by brazing. This fin fixing technique has several advantages. First of all, brazing the fins to tube 20 improves the heat exchange between the heating elements 50 and the fins. In addition, once the tube 20 has been brazed, the material of the tube 20, for example aluminium, will be more malleable and more easily deformable than before the brazing step, even after it has cooled to room temperature. This reduces the elastic relaxation that the material can have after deformation. In addition, this state of material guarantees a tight contact between the tube 20 and the heating elements 50 and therefore a better heat exchange. Brazing also ensures a longer life for tube 20 as it will be less sensitive to temperature changes and relaxation during the life of the electric heating block 1.

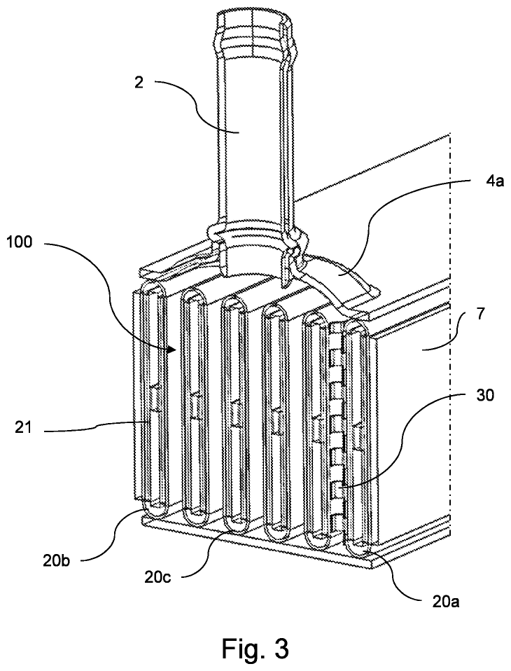

FIG. 3 shows a partial cross-section of the heater of FIG. 1. As can be seen, the large walls 21 of the first tube 20a and the second tube 20b are arranged perpendicularly with respect to the top plate 4 and the bottom plate 8. Between the first tube 20a and the second tube 20b there can be one or more further tubes 20c.

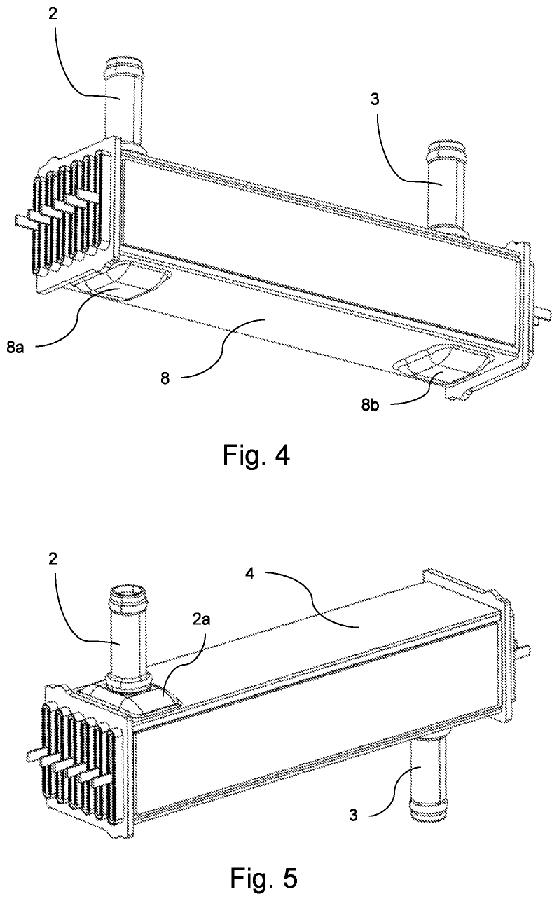

FIG. 4 presents another configuration of the electric fluid heater 1. The bottom plate 8 comprises at least one of its end portions a raised section 8a, 8b. In this case, the raised sections 8a, 8b is located at both ends. This can promote fluid distribution.

FIG. 5 shows yet another configuration of the electric fluid heater 1. In this example, the inlet 2 is connected to the top plate 4, while the outlet 3 is connected to the bottom plate 8.

Other variations to the disclosed embodiments can be understood and effected by those skilled in the art in practicing the claimed invention, from a study of drawings, the disclosure, and the appended claims. The mere fact that certain measures are recited in mutually different dependent claims does not indicate that a combination of these measures cannot be used to the advantage.

What is claimed is:

1. An electric fluid heater for a vehicle, comprising a heating block having an inlet and an outlet for the fluid, a first channel for the fluid intended to flow between the inlet and the outlet, a first tube and a second tube with opposing ends mounted in headers, the first and second tubes including heating elements, wherein the first channel is delimited by a top plate and a bottom plate sealingly connected to the first tube, the second tube and the headers.

2. The electric fluid heater according to claim 1, wherein the first tube and the second tube each comprise include two side walls connected by two large walls, wherein the top plate and the bottom plate are connected to side walls of the first tube and the second tube.

3. The electric fluid according to claim 2, wherein the large walls of the first tube and the second tube are arranged perpendicularly with respect to the top plate and the bottom plate.

4. The electric fluid heater according to claim 1, further comprising side plates connected to each of the first tube and the second tube in a parallel manner on the exterior of the heating block.

5. The electric fluid heater according to claim 4, wherein the side plate are distanced from the headers and the top plate and the bottom plate.

6. The electric fluid heater according to claim 1, wherein the top includes on at least one of its end portions a raised section.

7. The electric fluid heater according to claim 1, wherein the bottom plate includes on at least one of its end portions a raised section.

8. The electric fluid heater according to claim 6, the top plate including two raised sections, wherein the inlet and the outlet are each connected to one of the raised sections.

9. The electric fluid heater according to claim 1, wherein both the inlet and the outlet are connected to the top plate.

10. The electric fluid heater according to claim 1, wherein the inlet is connected to the top plate, while the outlet is connected to the bottom plate.

11. The electric fluid heater according to claim 1, wherein the headers comprise include a pair of protrusions extending perpendicularly to the axis of the first tube and the second tube.

12. The electric fluid heater according to claim 1, wherein between the first tube and the second tube there is one or more further tubes.

13. The electric fluid heater according to claim 1, further comprising side plates connected to the first tube or the second tube in a parallel manner on the exterior of the heating block.

14. The electric fluid heater according to claim 1, wherein the headers include a pair of protrusions extending perpendicularly to the axis of the first tube or the second tube.

15. The electric fluid heater according to claim 7, the bottom plate including two raised sections, wherein the inlet and the outlet are each connected to one of the raised sections.
